(19) United States
(12) Patent Application Publication
(10) Pub. No.: US 2007/0200953 A1
(43) Pub. Date: Aug. 30, 2007

(54) Method and Device for Displaying the Content of a Region of Interest within a Video Image

(76) Inventors: Yu-Ying Liu, Taipei Hsien (TW); Ying-Jui Lee, Kao-Hsiung City (TW); Yung-Hsiang Lin, Chang-Hua City (TW); Chia-Pei Chang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/307,955

(22) Filed: Feb. 28, 2006

(51) Int. Cl. H04N 5/44

(52) U.S. Cl. 348/561

(57) ABSTRACT

A method and device for displaying content of a region of interest within a video image is disclosed. The method includes: receiving a video signal from a video source; decoding the video signal to generate a video data corresponding to the video image; receiving at least a user command to modify the region of interest; and displaying the content of the modified region of interest on a screen according to part of the video data corresponding to the modified region of interest.

### BACKGROUND OF THE INVENTION

1. Field of the Invention

The present invention relates to a method for displaying a video image and the device thereof, and more specifically, to a method for displaying the content of a region of interest within a video image and the device thereof.

2. Description of the Prior Art

As is well known in the prior art, our current technology offers a massive volume of viewing choices. Viewers can access programming on their televisions that includes sports, drama, films, dance, and many other interesting topics. Often the viewer will wish to see a particular area of the video image in more detail than how it is being broadcast. In a first scenario, the viewer is a far distance from the display. For example, the display can be a television set. In this case, the user may not be capable of seeing certain details as those details are presented on the display as provided by the video source. For example, the video source can be the viewer's local cable operator or a satellite service similar to the DirectTV service. In this first scenario, the viewer will have difficulty seeing clearly all of the images on the display due to the far distance between the display and the viewer's location (e.g., resting on a sofa on the far of the room from where the television is positioned). In a second scenario, the viewer is watching a sporting event, such as a college football game. The quarterback is making a long run to the end zone in what might end in a possible touchdown and decide the game winner. The viewer is a huge football fan and wishes to enlarge the area of the display in and around the quarterback to better see the detail of the quarterback's feet, the boundary lines, the end zone, and the ball. Unfortunately, the camera crew for this football game is providing a rather wide focus shot that does not provide this football fan with an optimal viewing experience.

In all of these scenarios, and dozens more that are easily imagined, the viewer is unable to fully utilize the information of the screen image that is offered to them on their television display. As is well known to those skilled in this art, and as is well known to any television viewer, the displayed image transmitted by the provider (i.e., the source of the video signal) is offered in only one format and that is the format that the viewer must accept. It is apparent that better methods are required to offer viewers the ability to continently see, and read, their television screens.

### SUMMARY OF THE INVENTION

It is therefore one of the objectives of the claimed invention to provide a method for displaying the content of a region of interest within a video image. According to an embodiment of the present invention, the method comprises receiving a video signal from a video source; decoding the video signal to generate a video data corresponding to the video image; receiving at least a user command to modify the region of interest; and displaying the content of the modified region of interest on a screen according to part of the video data corresponding to the modified region of interest.

It is therefore another objective of the claimed invention to provide a device for displaying the content of a region of interest within a video image. According to an embodiment of the present invention, the device comprises a video decoder, coupled to a video source, for receiving a video signal from the video source and decoding the video signal to generate a video data corresponding to the video image; a frame buffer, coupled to the video decoder, for buffering the video data; a driver unit for receiving at least a user command to modify the region of interest; and a display unit, coupled to the frame buffer and the driver unit, for displaying the content of the modified region of interest on a screen according to part of the video data corresponding to the modified region of interest.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a device of the present invention for displaying the content of a region of interest within a video image.

FIG. 2 is a flowchart illustrating a region of interest selection according to a first embodiment of the present invention.

FIG. 3 shows an exemplary full screen video image displayed on a screen shown in FIG. 1.

FIG. 4 shows a first step of a selection of a region of interest performed on the image of FIG. 3 according the first embodiment of the present invention.

FIG. 5 shows a second step of the selection of the region of interest performed on the image of FIG. 4 according to the first embodiment of the present invention.

FIG. 6 shows a third and final step of the selection of the region of interest performed on the image of FIG. 5 according to the first embodiment of the present invention.

FIG. 7 shows a first zoom operation performed on the region of interest selection shown in FIG. 6 according to the first embodiment of the present invention.

FIG. 8 shows a second zoom operation performed on the region of interest selection shown in FIG. 7 according to the first embodiment of the present invention.

FIG. 9 shows a pan down operation performed on the region of interest selection shown in FIG. 8 according to the first embodiment of the present invention.

FIG. 10 is a flowchart illustrating a zoom operation according to a second embodiment of the present invention.

FIG. 11 shows another exemplary full screen video image displayed on a screen shown in FIG. 1.

FIG. 12 shows a first zoom operation performed on the image of FIG. 11 according to the second embodiment of the present invention.

FIG. 13 shows a second zoom operation performed on the image of FIG. 12 according to the second embodiment of the present invention.

FIG. 14 shows a third zoom operation performed on the image of FIG. 13 according to the second embodiment of the present invention.

FIG. 15 shows a fourth zoom operation performed on the image of FIG. 14 according to the second embodiment of the present invention.

FIG. 16 shows a pan right operation performed on the image of FIG. 15 according to the second embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

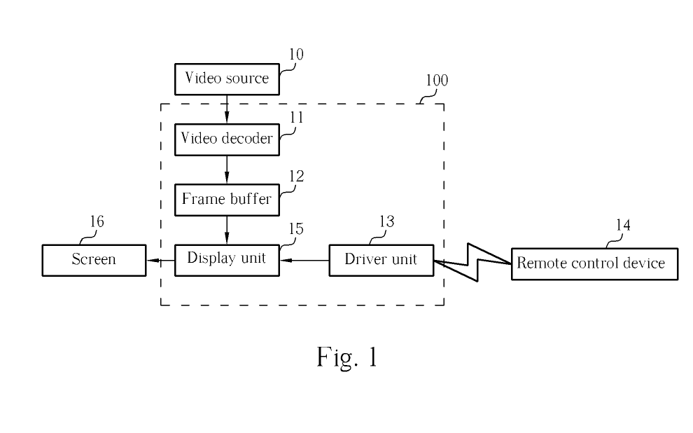

Please refer to FIG. 1. FIG. 1 is a block diagram illustrating a device 100 of the present invention for displaying the content of a region of interest (not shown in FIG. 1) within a video image. The device 100 is coupled to a video source 10 wirelessly or via a cable, where the video source 10 provides the device 100 with the desired video signal (i.e., the source signal). For example, the video source 10 can be a digital television signal provided by a digital television service provider. In the device 100, a video decoder 11, coupled to the video source 10, receives the video signal from the video source 10 and decodes the received video signal to generate a video data (not shown) corresponding to a video image (not shown in FIG. 1). The operation of the video decoder 11 is well known to those of average skill in the art and therefore further explanation is not necessary here. A frame buffer 12 is coupled to the video decoder 11. The frame buffer 12 buffers the video data. The operations of the frame buffer 12 are well known as well. A driver unit 13, in this embodiment, is for receiving at least a user command to modify the region of interest. The user command can originate from a remote control device 14 or any number of other means such as touch pad controls, on screen controls, or voice commands. Any method allowing the user to communicate their command desire to the driver unit 13 obeys the spirit of the present invention. A display unit 15 is coupled to the frame buffer 12 and the driver unit 13. The display unit 15 is for displaying the content of the modified region of interest on a screen 16 according to part of the video data corresponding to the modified region of interest. The screen 16 can be, for example, a display screen of television set, a display screen of a high-definition digital television set, and other such similar display apparatuses. Detailed descriptions and figures are included later for items not shown in FIG. 1, such as the region of interest, video data, and video image. Please note that the device 100 could be implemented in a TV set (e.g., digital TV) or a set-top box connected to a TV set.

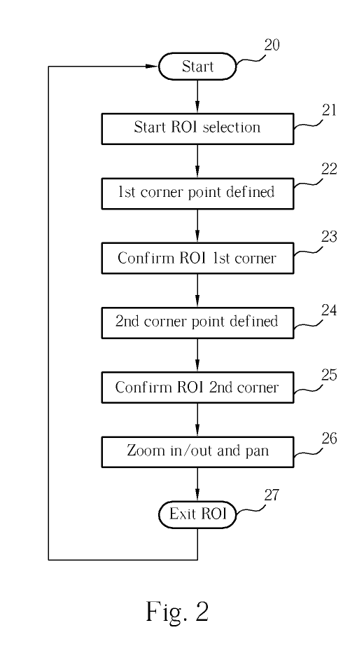

Please refer to FIG. 2. FIG. 2 is a flowchart illustrating a region of interest selection according to a first embodiment of the present invention wherein the user is utilizing a remote control device similar to a traditional TV, VCR, DVD remote, and the region of interest will be selected by the user. The method comprises the following steps:

Step 20: Initial state; a video image covers an entire screen. Region of interest covers entire video image. Video image is either active or frozen.

Step 21: Start this region of interest selection.

Step 22: A first corner point is defined.

Step 23: Confirm the first corner of a region of interest.

Step 24: A second corner point is defined.

Step 25: Confirm the second corner of the region of interest.

Step 26: Adjust zoom in and zoom out or directional pan.

Step 27: Exit this region of interest selection and go back to step 20.

As described briefly above in the steps, the screen 16 shows a full region of interest covering the entire video image in step 20. In other words, in the first embodiment as a default condition, without a specific region of interest being defined by the viewers the region of interest is set as being the entire video image. This is the situation until the user defines a different region of interest. The user can activate the present invention by, for example, pressing a button on a remote control device 14 shown in FIG. 1. As a first step, the first corner point to begin to define a polygon. The polygon in this example will be a simple rectangle and the rectangle is better known, in the present invention, as the region of interest. The initial setup for placing the first corner point of the region of interest is shown in step 21. Next, as shown in step 22, arrow keys are on the remote control device 14, and can be used for specifying where on the video image a first corner point will be defined. The user then presses, for example, an OK button in step 23 to define the first corner of the region of interest. Next, in step 24 the user utilizes the arrow keys again to specify where on the video image a second corner point will be defined. When defining the corner points, an arrow or hand or other appropriate icon can be displayed on the screen. Next, in step 25, the user presses the OK button to define the second corner of the region of interest. At this point, in step 26 the user can enjoy direct control of the defined region of interest. At the conclusion of step 25, the region of interest automatically zoomed to occupy the entire display area of the screen 16. Please note that an option can be included to account for zooming (or reducing) with or without maintaining the original aspect ratio. Either option obeys the spirit of the present invention. Continuing with step 26, the user can press buttons for zoom in/zoom out or directional pan in any direction, for example, left, right, up, and down, using corresponding keys on the remote control device 14. During the operation of step 26, please note that the video image can be frozen (i.e., paused or still motion) or the user can opt for the image to remain in motion (i.e., regular motion video). Using the remote control device 14 the user can easily switch between a frozen image and a moving image for displaying on the screen 16. In step 27 the user selects an exit button. As a result, the process of region of interest selection concludes and the video image on the screen 16 returns to full motion, the region of interest automatically defined as covering the entire video image. In other words, the initial state is entered again, and the video image appears unaltered as it arrives from the video source 10.

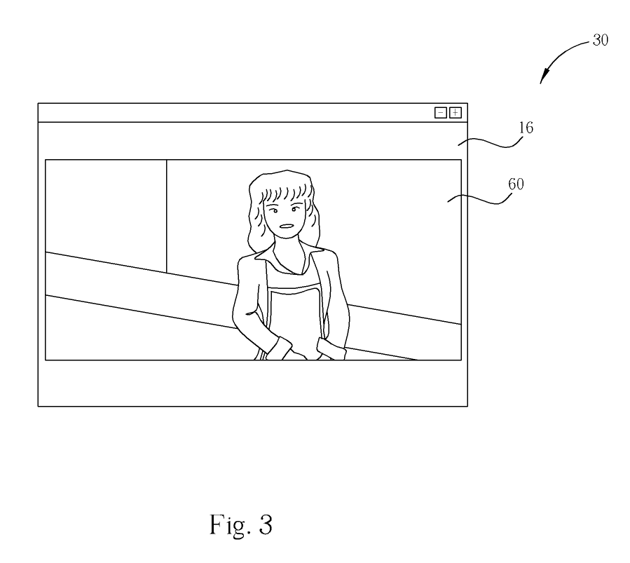

To better illustrate the operation of the present invention please consider the following example illustrating the first embodiment. Please refer to FIG. 3. FIG. 3 shows a full screen video image 60 as displayed in the screen 16. The region of interest is set to be the entire video image 60. In other words, the region of interest is a rectangle that encloses the video image 60. Please note that in FIG. 3 the region of interest is invisible to ensure that it does not interfere with clear viewing of the video image 60.

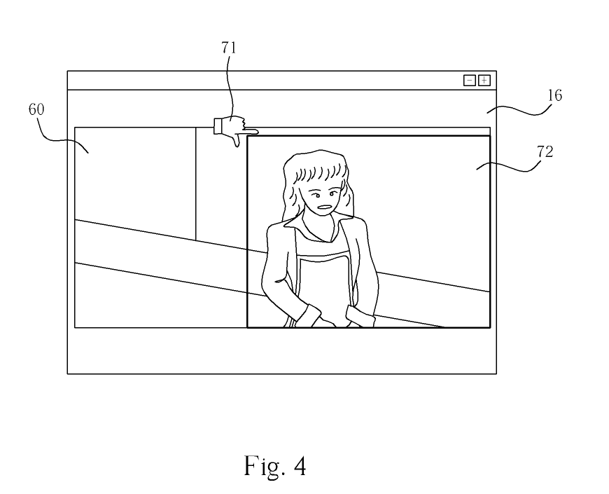

Please refer to FIG. 4. FIG. 4 shows a first step of a selection of a region of interest performed on the video image of FIG. 3 according the first embodiment of the present invention. Please note that certain objects are the same as those in FIG. 3 and the repetitive description has been omitted. The viewer presses a command button on the remote control device 14 and an icon 71 appears for allowing the viewer to define a first corner of the region of interest 72. Note that the region of interest 72 is not yet set and therefore is dynamic in FIG. 4. Using the arrow key commands the viewer moves icon 71 and accepts a first corner of the region of interest.

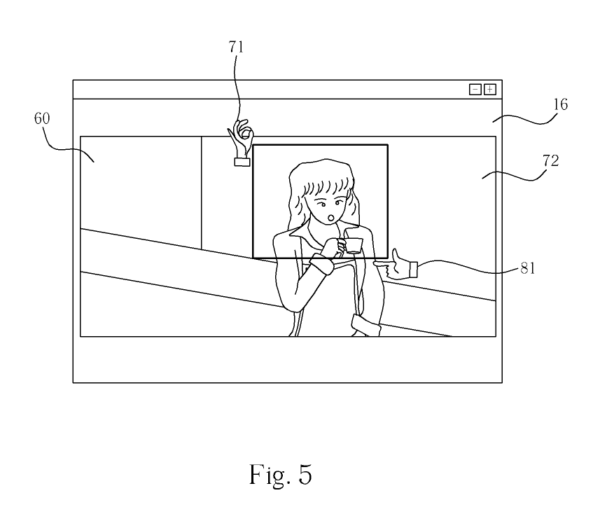

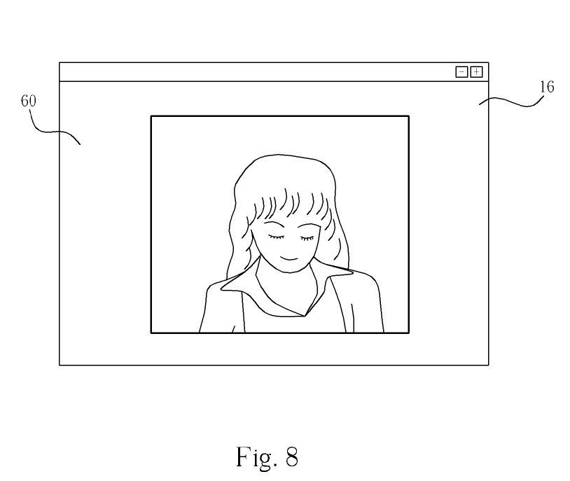

Please refer to FIG. 5. FIG. 5 shows a second step of the selection of the region of interest performed on the video image of FIG. 4 according to the first embodiment of the present invention. Please note that certain objects are the same as those in FIG. 4 and the repetitive description has been omitted. The video image 60 remains in the background, however, it is the same video signal stream but the image is active and in motion so the content of video image 60 has indeed changed from the video image 60 shown in previous figures. More importantly, icon 71 has been set and now a second icon, icon 81 appears allowing the viewer to set the second and final corner of the region of interest 82. As shown in FIG. 8 the region of interest 82 is not necessarily set. The user can still utilize commands via the remote control device 14, such as the arrow keys, to move the icon 81 thereby changing the size and shape of the region on interest 82. Note how the content of the region of interest 82 is clearly visible especially because the video image 60 outside of the region of interest 82 is slightly dimmed.

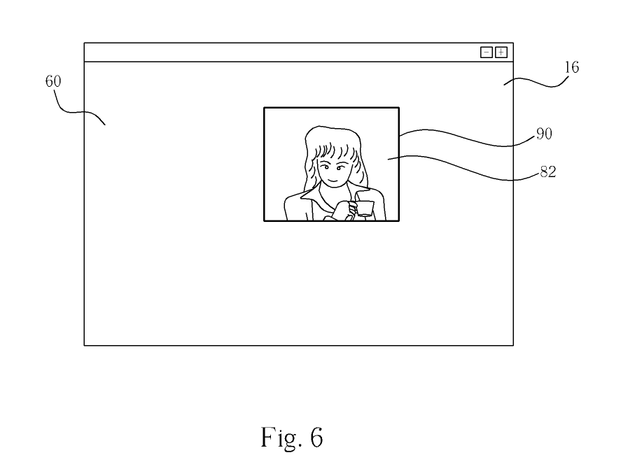

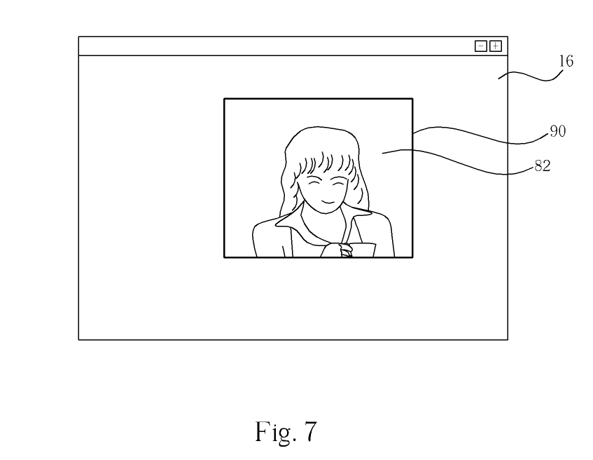

Please refer to FIG. 6. FIG. 6 shows a third and final step of the selection of the region of interest performed on the image of FIG. 5 according to the first embodiment of the present invention. Please note that certain objects are the same as those in FIG. 5 and the repetitive description has been omitted. Now the viewer presses an OK button or some other equivalent command button on, for example, the remote control device 14. This action causes the portion of the video image 60 that is outside of the region of interest 82 to become completed blacked out. Additionally, the region of interest 82 is now set (i.e., defined) and this is obvious to the viewer because a region of interest border 90 becomes visible. The border 90, the color, width, and any other attributes of the border 90 are shown as examples only and not meant to be taken as limitations of the present invention. Having set the region of interest 82 the present invention performs a zoom operation to full the screen 16 with the content of the region of interest 82 as shown in FIG. 7.

Please refer to FIG. 7. FIG. 7 shows a first zoom operation performed on the region of interest selection shown in FIG. 6 according to a first embodiment of the present invention. Please note that certain objects are the same as those in FIG. 6 and the repetitive description has been omitted. The user continues the zoom operation by again pressing the zoom command on the remote control device 14. The zoom operation is handled by the display unit 15 shown in FIG. 1. The display unit 15 includes a video scaler and can perform a scaling operation, for example, to achieve the zoom effect. This causes the content of the region of interest 82 as defined by the area enclosed by the border 90 to be enlarged on the video display 16 as shown in FIG. 8.

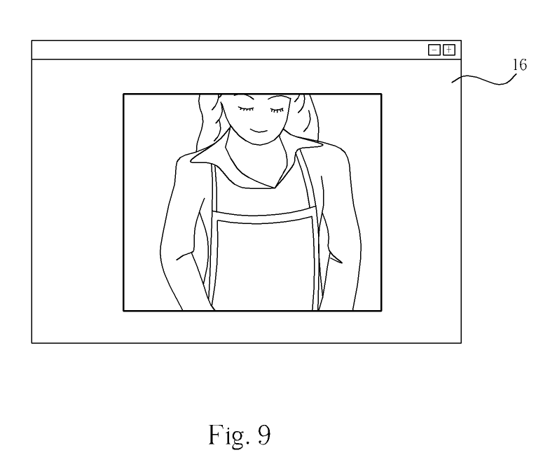

Please refer to FIG. 8. FIG. 8 shows a second zoom operation performed on the region of interest selection shown in FIG. 7 according to the first embodiment of the present invention. Please note that certain objects are the same as those in FIG. 7 and the repetitive description has been omitted. The user presses the pan button, specifically, the pan down button on the remote control device 14. This causes the region of interest to be redefined once again thereby allowing the viewer to see a slightly different portion of the video image 60. As shown in FIG. 9, the results of the pan down operation are visible.

Please refer to FIG. 9. FIG. 9 shows a pan down operation performed on the region of interest selection shown in FIG. 8 according to the first embodiment of the present invention. Please note that certain objects are the same as those in FIG. 9 and the repetitive description has been omitted. At this point, the viewer has zoomed in and then panned to a specific area of interest. The viewer can press an exit button on the remote control device 14 to reset the region of interest. At that point, the video image 60 will return to the same image scenario or at least one very similar to what is shown in FIG. 3, however, the image content will of course be different since during the operations of defining the region of interest, zooming, and panning, the video image 60 has been active.

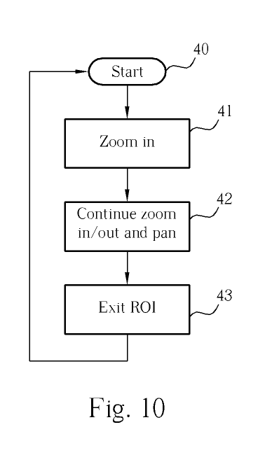

Please refer to FIG. 10. FIG. 10 is a flowchart illustrating a region of interest selection according to a second embodiment of the present invention. The method comprises the following steps:

Step 40: Initial state; a video image 60 covers an entire screen. Region of interest covers entire video image 60. Video image 60 is either active or frozen.

Step 41: Zoom in; region of interest is automatically defined.

Step 42: Adjust zoom in and zoom out or directional pan. Region of interest is automatically set.

Step 43: Exit this flow of region of interest selection and go back to step 40.

As described briefly above in the steps, the screen 16 shows a full region of interest covering the entire video image 60 in step 40. In other words, in the second embodiment the region of interest is set as being the entire video image 60 until the user activates the present invention by, for example, pressing a button on a remote control device 14 to zoom in as shown in step 41. Because of the zoom in command, the region of interest is set, however, in this embodiment it is set automatically. Next, in step 42 the viewer utilizes the arrow keys on the remote control device 14 to pan in the left, right, up, and down directions. Additionally, in step 42 the user can perform subsequent zoom in and zoom out commands. In step 43, the user selects an exit button. As a result, the process of region of interest selection concludes and the video image 60 on the screen 16 returns to full motion with the region of interest automatically defined as covering the entire video image 60. In other words, the initial state is entered again, and the video image 60 appears unaltered as it arrives from the video source 10.

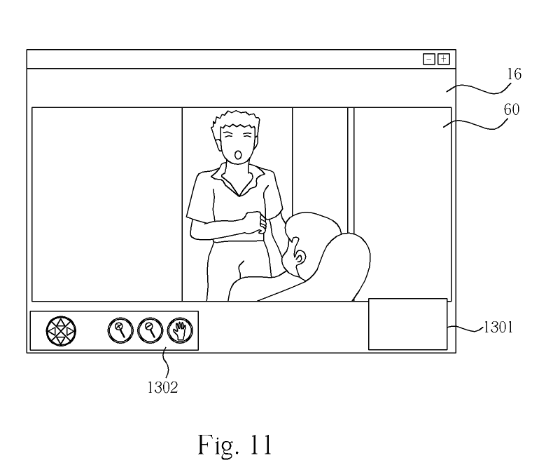

In the second embodiment, the content of the selected region of interest for the original video image 60 fills an active display area of the screen 16. In addition, the display unit 15 is defined to further display a thumbnail on the screen 16 to indicate a location of the actual region of interest within the video image 60. To better illustrate the operation of the present invention please consider the following example illustrating the second embodiment. Please refer to FIG. 11. FIG. 11 shows a full screen video image according to the second embodiment of the present invention. In this example, the region of interest 1300 covers the entire video image 60 as shown in the screen 16. A thumbnail 1301 shows the region of interest with respect to the video image 60. A control pad 1302 shows the commands that are available to the viewer. The viewer begins by pressing the zoom command key on the remote control device 14.

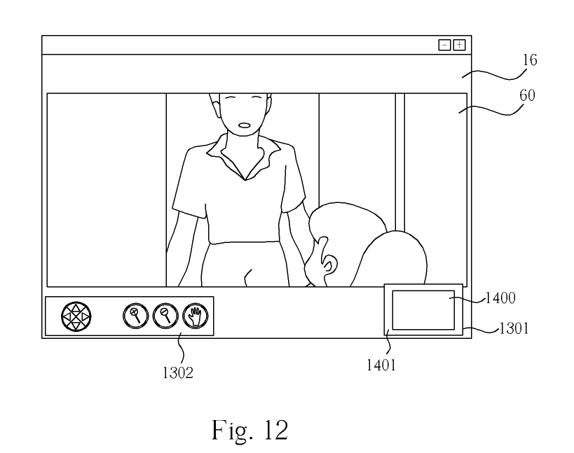

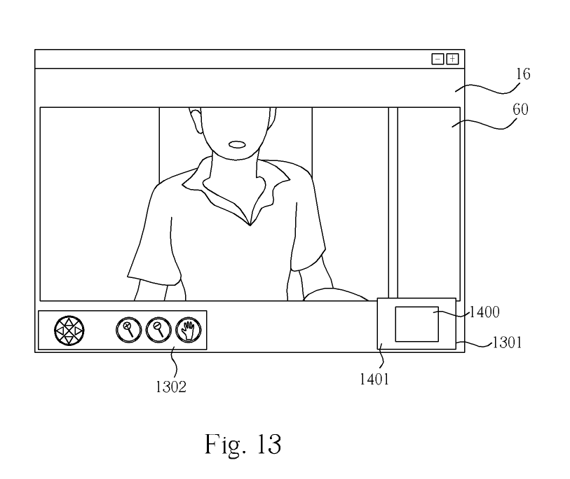

Please refer to FIG. 12. FIG. 12 shows a first zoom operation performed on the image of FIG. 13 according to a second embodiment of the present invention. Please note that certain objects are the same as those in FIG. 11 and the repetitive description has been omitted. As is clearly visible, the content of the video image 60 has been enlarged (i.e., zoomed). This is also indicated by the thumbnail 1301. In the displayed thumbnail 1301 representative of the original video image 60, the region of interest 1400 shows the area of the video image 60, i.e., the region of interest that is currently being displayed on the screen 16. The clip area 1401 shows the portion of the video image 60 that has been clipped (i.e., cropped) to facilitate the desired zooming level of the video image 60. Note how the region of interest 1400 and the clip area 1401 within the thumbnail 1301 change their size with respect to one another between FIG. 12 through FIG. 16.

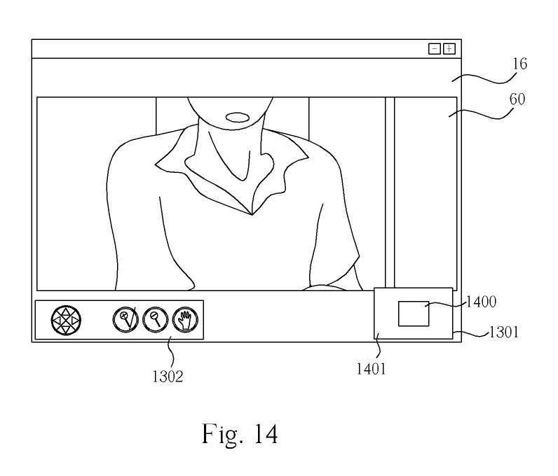

Please refer to FIG. 13. FIG. 13 shows a second zoom operation performed on the image of FIG. 14 according to the second embodiment of the present invention. The additional zoom command has enlarged the content of the region of interest. Accordingly, the representative region of interest 1400 shown in the thumbnail 1301 changes. Please note that certain objects are the same as those in FIG. 12 and the repetitive description has been omitted.

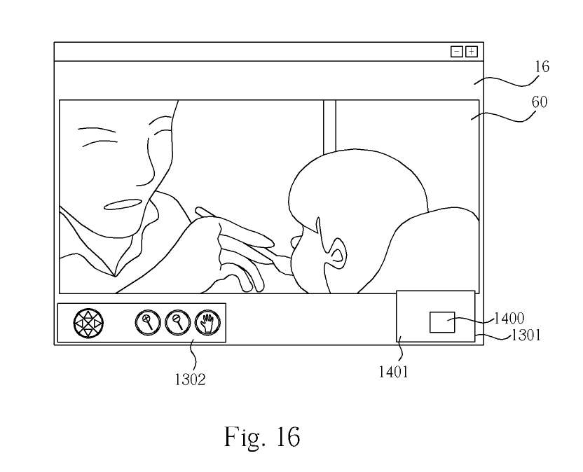

Please refer to FIG. 14. FIG. 14 shows a third zoom operation performed on the image of FIG. 13 according to the second embodiment of the present invention. A last zoom command enlarges the video image 60 even more. Note the changes as described for FIG. 13 is very similar to those of FIG. 16. The representative region of interest 1400 shown in the thumbnail 1301 grows even smaller allowing the clip area 1401 is increase thereby enlarging the video image 60 on the screen 16. Please note that certain objects are the same as those in FIG. 13 and the repetitive description has been omitted.

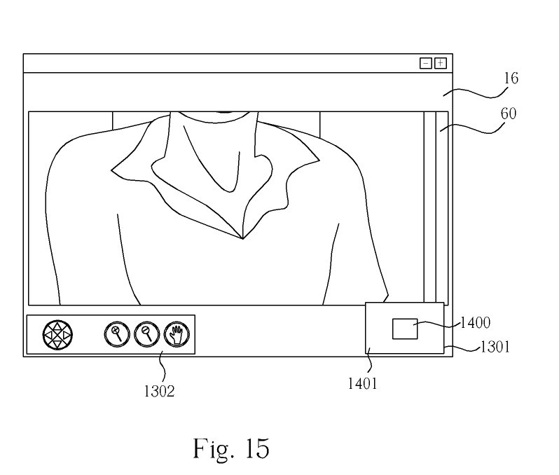

Please refer to FIG. 15. FIG. 15 shows a fourth zoom operation performed on the image of FIG. 14 according to the second embodiment of the present invention. The viewer decides to pan right because the resulting zoomed video image 60 is not exactly the desired region of interest 1400. Note that the thumbnail 1301 provides excellent visual feedback for the viewer to select a correct zoom or pan command to achieve the exact desired region of interest. Please note that certain objects are the same as those in FIG. 14 and the repetitive description has been omitted.

Please refer to FIG. 16. FIG. 16 shows a pan right operation performed on the image of FIG. 15 according to the second embodiment of the present invention. The results of the pan operation of FIG. 15 are shown in FIG. 16. The viewer has now achieved their desired region of interest. That is, as shown in FIG. 16, the representative region of interest 1400 has located the desired portion of the video image 60 that actually interests the viewer. Please note that certain objects are the same as those in FIG. 15 and the repetitive description has been omitted.

Please note, it is optional that the user/viewer issue a freeze (i.e., pause) command as a way of activating the present invention. It is also an option that they user issue a freeze command at any time during the zooming and panning operations or even during the process of placing polygon points to define the region of interest rectangle. In this case, the video image 60 is frozen during all subsequent operations, such as: zooming and panning. Eventually when the viewer releases the video image 60 the video image 60 will become an active full motion video once again according to the video signal. The option of freezing the video image 60 is available in both the first and second embodiments.

In summary, the present invention provides a method and device for displaying the content of a region of interest within a video image thereby saving the viewer from many inconveniences associated with watching a displayed image in only the format as provide by a service provide such as a cable company.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying content of a region of interest within a video image, the method comprising:
receiving a video signal from a video source;
decoding the video signal to generate a video data corresponding to the video image;
receiving at least a command signal to modify the region of interest; and
displaying the content of the modified region of interest on a screen according to part of the video data corresponding to the modified region of interest.

2. The method of claim 1, wherein modifying the region of interest further comprises:
setting a plurality of polygon coordinate points on an active display area of the screen to define the region of interest.

3. The method of claim 2, wherein displaying the content of the region of interest further comprising:
scaling the content of the region of interest.

4. The method of claim 3, wherein modifying the region of interest comprises:
panning the region of interest within the video image after the content of the region of interest is scaled.

5. The method of claim 2, wherein modifying the region of interest comprises:
panning the region of interest within the video image.

6. The method of claim 1, wherein the content of the region of interest fills an active display area of the screen.

7. The method of claim 6, wherein modifying the region of interest comprises:
scaling the region of interest within the video image.

8. The method of claim 7, wherein modifying the region of interest further comprises:
panning the region of interest within the video image.

9. The method of claim 6, wherein modifying the region of interest further comprises:
panning the region of interest within the video image.

10. The method of claim 6, further comprising:
displaying a thumbnail on the screen to indicate a location of the region of interest within the video image.

11. The method of claim 1, wherein the video image is a still image or a motion video image according to the source.

12. The method of claim 1, wherein the video image is a motion video image and the motion video image remains in motion during modifying the region of interest.

13. The method of claim 1, wherein the video signal complies with the digital TV specification.

14. A device for displaying content of a region of interest within a video image, the device comprising:
a video decoder, coupled to a video source, for receiving a video signal from the video source and decoding the video signal to generate a video data corresponding to the video image;
a frame buffer, coupled to the video decoder, for buffering the video data;
a driver unit for receiving at least a command signal to modify the region of interest; and
a display unit, coupled to the frame buffer and the driver unit, for displaying the content of the modified region of interest on a screen according to part of the video data corresponding to the modified region of interest.

15. The device of claim 14, wherein the driver unit receives a plurality of command signals indicating a plurality of polygon coordinate points on an active display area of the screen, and the driver unit modifies the region of interest according to the polygon coordinate points.

16. The device of claim 15, wherein the display unit further scales the content of the region of interest.

17. The device of claim 16, wherein the driver unit further pans the region of interest within the video image after the content of the region of interest is scaled.

18. The device of claim 15, wherein the driver unit further pans the region of interest within the video image.

19. The device of claim 14, wherein the content of the region of interest fills an active display area of the screen.

20. The device of claim 19, wherein the display unit further scales the region of interest within the video image.

21. The device of claim 20, wherein the display unit further pans the region of interest within the video image.

22. The device of claim 19, wherein the display unit further pans the region of interest within the video image.

23. The device of claim 19, wherein the display unit further displays a thumbnail on the screen to indicate a location of the region of interest within the video image.

24. The device of claim 14, wherein the video image is a still image or a motion video image according to the source.

25. The device of claim 14, wherein the video image is a motion video image and the motion video image remains in motion during modifying the region of interest.

26. The device of claim 14, wherein the video signal complies with the digital TV specification.

27. The device of claim 26, wherein the video decoder, the frame buffer, the display unit, the driver unit, and the screen are all disposed within a TV.

28. The device of claim 26, wherein the video decoder, the frame buffer, the display unit, and the driver unit are all disposed within a set-top box coupled to the screen of a TV.
